(19) United States
(12) Patent Application Publication
(10) Pub. No.: US 2026/0079287 A1
(43) Pub. Date: Mar. 19, 2026

(54) REFLECTION MITIGATION STRUCTURE FOR LIGHT MEASURING TUNNELS

(71) Applicant: Dajac, Inc, Sheridan, IN (US)

(72) Inventors: David Novak, Sheridan, IN (US); Cody Turner, Spiceland, IN (US); Chuck Teague, Zionsville, IN (US); Alberto Ramirez Uyeno, Indianapolis, IN (US)

(73) Assignee: Dajac, Inc, Sheridan, IN (US)

(21) Appl. No.: 19/327,793

(22) Filed: Sep. 12, 2025

Related U.S. Application Data
(60) Provisional application No. 63/696,084, filed on Sep. 18, 2024.

(51) Int. Cl. G02B 5/20; G01M 17/007; G03B 15/06

(52) U.S. Cl. CPC G02B 5/201; G01M 17/007; G03B 15/06

(57) ABSTRACT

A reflection mitigation structure for a light measuring tunnel includes a tunnel having a floor, a ceiling, a first wall, a second wall, a first end, and a second end. The first end is configured for receiving a light source and the second end is configured for supporting a screen positioned for receiving light from the light source. The reflection mitigation structure includes a backing board layer, foam board layer, and a honeycomb layer. The reflection mitigation structure is secured to surfaces of the floor, the ceiling, the first wall, and the second wall, with the honeycomb layer including a plurality of cells having predetermined depths for capturing reflected light.

### CROSS-REFERENCE TO RELATED APPLICATION

The present application claims the benefit of U.S. Provisional Patent Application No. 63/696,084, filed on 18 Sep. 2024, which is incorporated herein by reference.

### TECHNICAL FIELD

The present invention relates to light control devices and methods, and more particularly, to devices for controlling light in a designated space by controlling reflected light.

### BACKGROUND

Several applications exist where one needs to control light within the space, and in particular, control reflected light within the space. One such application resides in the photographic arts, where a photographer may wish to control lights in a manner where either the reflected light is accentuated or diminished.

Another application exists wherein lighting and lighting systems are being tested. Such an application exists within the photography field, or the general lighting field, where one wishes to measure the intensity of the light emitted by a light emitting object, such as a bulb; or otherwise wishes to determine and/or measure the area and/or position of a surface upon which the light shines.

One application where light and lighting characteristics are very often tested is in the testing of vehicle lights and lighting assemblies and lighting systems. Vehicle light testing occurs because safety, insurance standards, and governmental regulations often mandate that the light emitted from a vehicle have certain characteristics. These characteristics include such things as the intensity of the light, and the area on which the light shines.

For example, regulations governing headlamps for cars require that the light shine at a certain intensity, and impinge an area that is usually height-and/or direction limited so as to prevent the light being emitted from impairing the vision of an oncoming driver. For example, the light emitted from the low beams of a vehicle should be most intense at a height lower than that of the high beams.

It is common in the industry to use a tunnel system to measure the light. However, although the testing area should be enclosed to minimize the amount of ambient light ingress therein, the area need not be tunnel shaped, but can comprise a room or other volumetric area. Unless clearly indicated otherwise, the term tunnel should be construed broadly enough to include a generally enclosed space of any shape, size, or configuration.

The use of a tunnel system provides a lamp manufacturer with the ability to test their automotive head lamp systems to ensure compliance with mandated government and insurance industry requirements prior to incorporating the lamps in the vehicle. These tunnel systems usually comprise an enclosed space similar to an enclosed room that is commonly installed on a factory floor and made to be “light tight” to prevent ingress of ambient light.

Similarly, within the interior of the tunnel, it is highly preferred that the only light that is projected onto the screen, or wall at the opposite end of the tunnel is the light from the light source being tested. Since the tunnel is designed to project an actual or emulated required distance, it is typical that some light from a single lamp or multiple lamps will impact the floor, side or top walls of the tunnel interior and be reflected numerous times within the tunnel.

This reflected light resolves onto the screen, impacting the accuracy of the measurement, potentially causing an improper rejection of the lamp or other light system that is being measured. The present technology addresses deficiencies in the current state of reflection mitigation systems.

### SUMMARY

The present disclosure comprises a reflection mitigation system including a tunnel having a floor, a ceiling, a first wall, a second wall, a first end, and a second end. The first end is configured for receiving a light source and the second end is configured for supporting a screen positioned for receiving light from the light source.

A reflection mitigation structure includes a substrate, such as an insulation board layer, a foam layer, and a honeycomb layer. The reflection mitigation structure is secured to surfaces of the floor, the ceiling, the first tunnel side wall, and the second tunnel side wall. The honeycomb panel layer includes a plurality of cells having predetermined depths for capturing reflected light.

In accordance with another embodiment of the present invention, a reflection minimizing panel is provided. The panel includes a substrate having an outer wall and an inner wall. The inner wall includes a reflection reducing surface. A reflection reducing member is coupled to the reflection minimizing panel that includes a plurality of cells, with each cell including a wall and an interior that defines a light receiving cavity. The cells are arrayed in a manner such that each cell shares a wall with at least three other cells.

Preferably, the cells have a honey comb shape having a quadrilateral, pentagonal, hexagonal, heptagonal or octagonal cross-sectional shape. Alternately, in another preferred embodiment, the cells have a cylindrical or other shape.

Preferably, the panel includes a substrate on which the other components can be mounted. Examples of suitable substrates include foam boards, insulation boards and suitably stiff and robust cardboard. A foam layer is disposed over the supporting substrate and has an inner wall surface, wherein the inner wall surface of the foam layer includes a reflection reducing surface. A reflection reducing member is coupled to the reflection reducing surface of the foam layer and comprises a plurality of cavity containing cells.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts a perspective view of a light measuring tunnel, according to an embodiment of the present disclosure;

FIG. 2 depicts a view of a single lamp light source positioned relative to an exemplary tunnel having a baffle;

FIG. 3 depicts a view of the single lamp light source of FIG. 2, with the baffle in a different position;

FIG. 4 depicts a view of the single lamp light source of FIGS. 2 and 3, with the baffle in another position;

FIG. 5 depicts a view of a multiple lamp light source positioned relative to the exemplary tunnel;

FIG. 6 depicts a view of the multiple lamplight source of FIG. 5, with a shortened baffle;

FIG. 7 depicts an exploded view of a light measuring tunnel of FIG. 1, including the reflection mitigation system;

FIG. 8 depicts a side view of layers of the reflection mitigation structure, according to an embodiment of the present disclosure;

FIG. 9 depicts a view of a honeycomb layer for use in the present disclosure; and

FIG. 10 depicts a view of a screw fastener for use in assembling the reflection mitigation structure of the present disclosure.

Like reference numbers and designations in the various drawings indicate like element.

### DETAILED DESCRIPTION

Before the present methods, implementations, and systems are disclosed and described, it is to be understood that this invention is not limited to specific methods, specific components, implementation, or to particular compositions, and as such may, of course, vary. It is also to be understood that the terminology used herein is for the purpose of describing particular implementations only and is not intended to be limiting.

As used in the specification and the claims, the singular forms “a,” “an” and “the” include plural referents unless the context clearly dictates otherwise. Ranges may be expressed in ways including from “about” one particular value, and/or to “about” another particular value.

When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

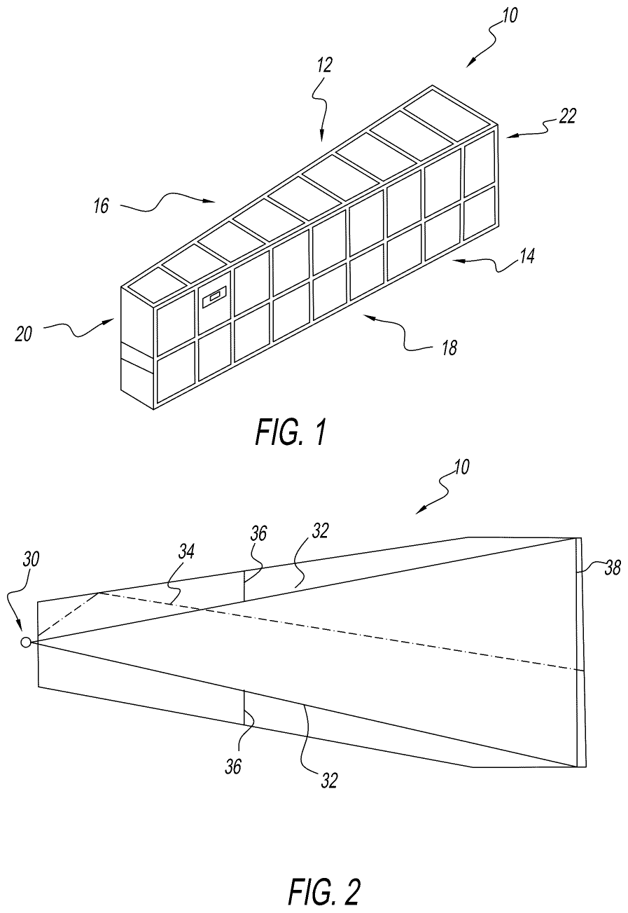

FIG. 1 depicts an exemplary light measuring tunnel 10, according to the present disclosure. The light measuring tunnel 10 has a ceiling 12, a floor 14, a first side wall 16, and a second side wall 18. The light measuring tunnel 10 also includes a first end 20 and a second end 22, with the second end 22 having increased dimensions (e.g., greater height and/or width) relative to the first end 20.

For example, the cross-sectional area of the tunnel 10 may gradually become larger along its length from the first end 20 to the second end 22 as the first and second side walls 16, 18 diverge. The tunnel 10 may be sized and configured to define an enclosed space for measuring and/or testing lighting systems or sources, such, for example, as automotive lighting.

The first end 20 is configured to accommodate a light source and may include a light-source holding fixture therefor. The second end 22 is configured for accommodating a screen for receiving light from the light source.

Turning now to FIG. 2, a single lamp light source 30 produces direct light 32 and reflected light 34. FIG. 2 also depicts a light-blocking baffle 36 positioned at an approximately central location of the length of tunnel 10 for blocking light at angles greater than screen 38. The baffle 36 blocks much light, but includes an aperture through which light can pass.

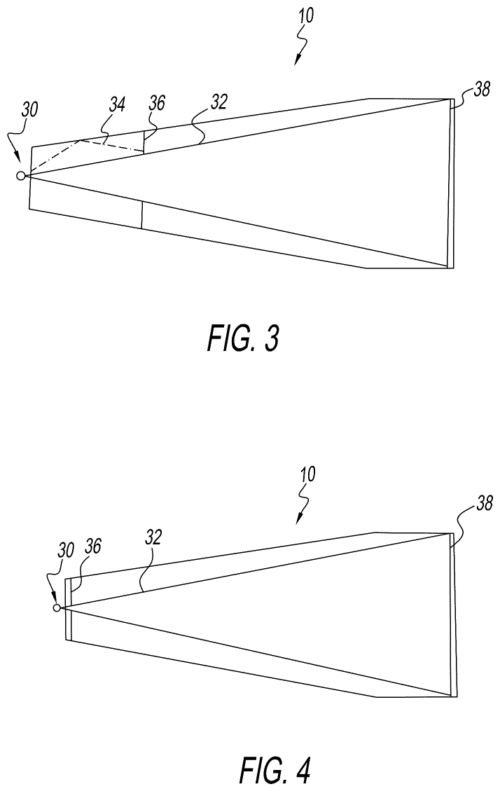

However, as shown, some reflected light 34 may still reach the screen 38. Moving the baffle(s) 36 closer to the light source 30 blocks more reflections 34, as shown in FIG. 3. Positioning the baffles 36 near the light source 30, as shown in FIG. 4 blocks all reflections.

The baffles 36 are configured to block light from passing through the opaque portion of the baffle 36, while defining an opening or aperture through which light can pass.

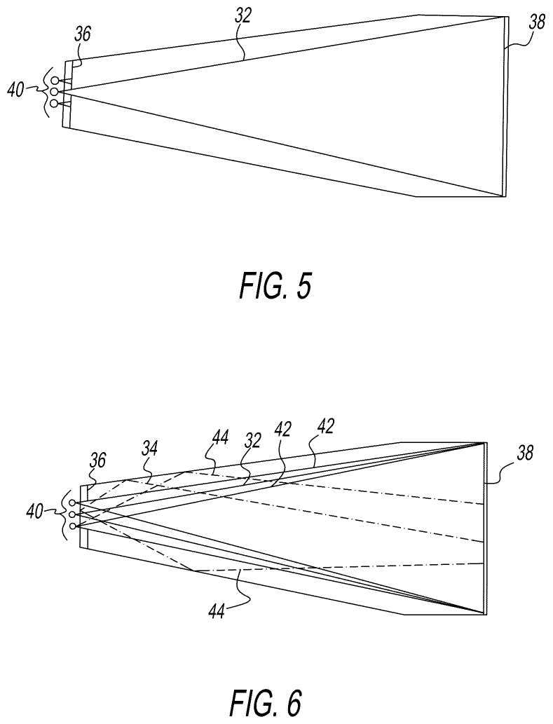

However, as shown in FIG. 5, baffles 36 at the optimum position for a single lamp light source 30 block other sources in a multiple lamp light source 40, causing shadows to form on the screen 38. Reducing the area of the opaque portion of the baffles 36 to thereby increase the area of the aperture of the baffles 36 allows the other light sources 42 to project on the screen 38, but also allows many reflections 34 and 44 (FIG. 6).

With multiple lamp light sources 40, no position of traditional baffles will block all reflections. This reflected light resolves onto the screen 38, impacting the accuracy of the measurement, causing an improper result when testing and/or measuring a light source.

This reflected light from multiple light sources creates a significant issue as many modern LED based automotive light systems contain multiple light sources.

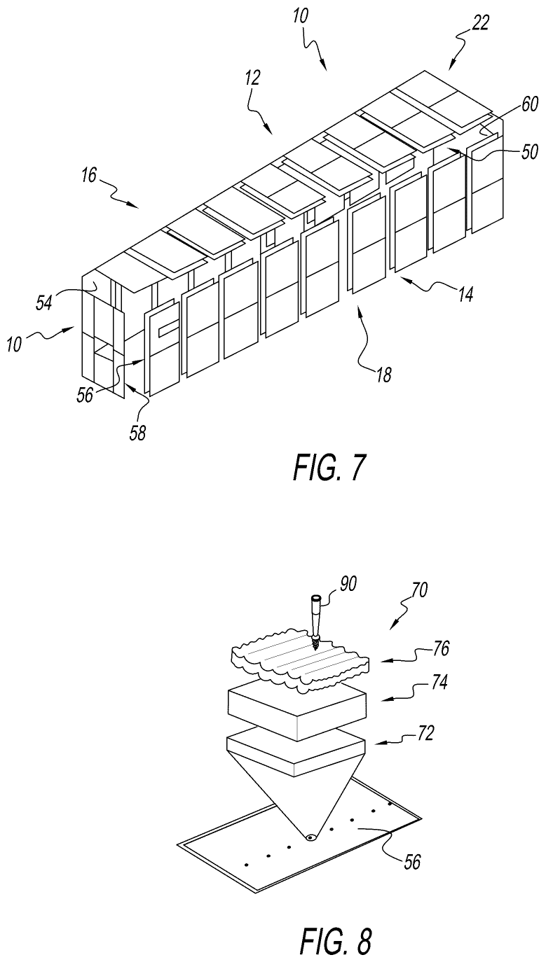

FIG. 7 depicts an exploded view of the tunnel 10 of FIG. 1, illustrating inner surfaces 50, 52, 54, and 56 of the tunnel 10 on which a reflection mitigation structure, discussed below, is secured. According to an exemplary embodiment, the reflection mitigation structure is fastened to surfaces 54 and 56 of the first wall 16 and the second wall 18. According to other embodiments, the reflection mitigation structure may also be fastened to the surfaces 50 of the ceiling 12 and the floor 14.

Turning now to FIG. 8, a preferred reflection mitigation structure 70 comprises a multilayer structure that includes a backing board layer 72, a porous foam layer 74, and a honeycomb layer 76. The backing board layer 72 may include polystyrene, cardboard, or drywall, and is configured to provide a supportive substrate to the reflection mitigation structure 70 as it is placed in a vertical position alongside the interior surfaces 54, 56 of walls 16 and 18 or the interior surfaces of the ceiling and floor. For example, the mitigation structure 70 can be placed on a horizontal surface such as the floor 14 and ceiling 50 of the tunnel.

A polystyrene insulation board or some other suitably stiff substrate, such as 0.5 inch reinforced cardboard, or a stiff plastic or Masonite sheet may be used as a semi-rigid structure,. This semi-rigid structure may be applied directly to and mounted on drywall in the final structure

The inner foam layer 74 may be a reticulated foam, approximately 1 inch thick with 10% dense foam, and may be adhesively bonded to the backing board layer 72. The foam layer 74 may provide a structure for the honeycomb layer 76 to adhere to and a surface where the light within the interior of the cell will bounce and be redirected away from the screen 38. The honeycomb layer 76 may be, for example, 0.5 inch polycarbonate honeycomb.

Most preferably, the honeycomb cells comprise generally cylindrical cells having a circular cross-section, having a diameter of about 0.25 inches. However, cells having other shapes, such as the quadrilateral, pentagonal, hexagonal, etc. mentioned above, and other diameters may work well in the present invention.

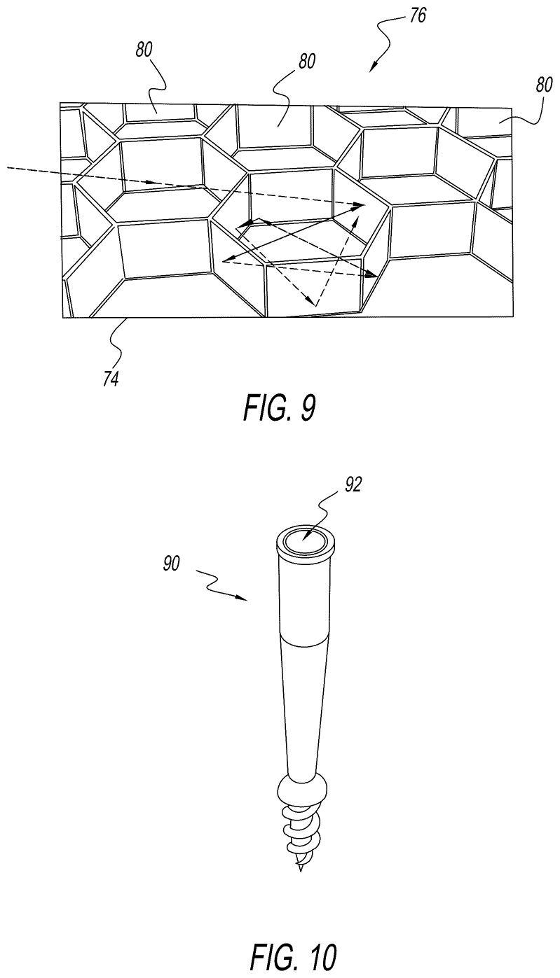

Turning now to FIG. 9, the honeycomb layer 76 usually functions as a primary light mitigation material, while the foam layer 74 usually functions as a secondary light mitigation material. The honeycomb layer 76, preferably includes cells 80 having either a hexagonal or circular cross section. The cells 80 and foam 74 serve as a light trap where the incident light rays bounce into cells 80 and foam 74, preventing the reflections from escaping back into the tunnel 10, as shown in FIG. 9. Additionally, the material used should be black and as non-reflective as possible for optimizing reflection reduction to thereby achieve.

Fasteners 90 are used for securing layers of the reflection mitigation structure 70 and are shown in FIG. 10. The fasteners 90 are designed to minimize reflection through the use of surface roughness and light trapping similar to that provided by the honeycomb structure 76. As shown in FIG. 10, the fasteners 90 may include blind apertures 92 at their ends that face the interior of the tunnel to mitigate reflections in a manner similar to the manner in which the cells 80 mitigate reflections.

The reflection mitigation structure 70 reduces the reflection that occurs from the light source 30, 40 light reflecting from the ceiling, floor, and walls. The use of the reflection mitigation structure 70 enhances the accuracy of measurements of light intensities in a test tunnel for light sources 30, 40, such as automotive lamp systems.

The reflection mitigation structure 70 may be further extended to non-automotive applications where the light source requires similar measurements that necessitate an enclosed system. These systems could include other environments where reflective light needs to be controlled, such as photographic applications, cinematic applications and other, non-vehicle related light testing applications.

What is claimed is:

1. A reflection mitigation system for measuring light, the reflection mitigation system comprising:
a light-controlled space, the light-controlled space being defined by a floor, a ceiling, a first wall, a second wall, a first end, and a second end;
wherein the first end is configured for receiving a light source;
wherein the second end is configured for supporting a light receiving surface positioned for receiving light from the light source; and
a reflection mitigation structure supported on surfaces of the first wall and the second wall;
wherein the reflection mitigation structure includes a backing board layer, a foam
layer, and a honeycomb layer;
wherein the honeycomb layer includes an array of cells having predetermined depths for capturing light.

2. The reflection mitigation system of claim 1, wherein the reflection mitigation structure is also supported on surfaces of the floor and the ceiling.

3. The reflection mitigation system of claim 1, wherein the light source includes a single lamp light source.

4. The reflection mitigation system of claim 1, wherein the light source includes a multiple lamp light source.

5. The reflection mitigation system of claim 1, wherein the honeycomb layer includes walls defining a plurality of hollow hexagonal cells.

6. The reflection mitigation system of claim 1, wherein the honeycomb layer includes walls defining a plurality of hollow circular cells.

7. The reflection mitigation system of claim 1, wherein the inner layer is a reticulated foam pad.

8. The reflection mitigation system of claim 1, further including a plurality of screw fasteners for securing together the layers of the reflection mitigation structure, wherein each of the screw fasteners includes an aperture containing head portion.

9. The reflection mitigation system of claim 1, further including at least one baffle supported within the tunnel for blocking or redirecting light in the tunnel, the baffle defining an aperture through which light can pass.

10. The reflection mitigation system of claim 1, wherein the honeycomb layer includes walls defining a plurality of hollow circular cells having a diameter of between about 0.2 and 0.5 inches.

11. The reflection mitigation system of claim 1, wherein the honeycomb layer includes walls defining a plurality of hollow circular cells having a diameter of about 0.25 inches.

12. A reflection minimizing panel for a reflection mitigation system for measuring light, comprising:
a substrate having an outer wall and an inner wall, wherein the inner wall includes a reflection reducing surface; and
a reflection reducing member coupled to the reflection reducing surface that includes a plurality of cells, with each cell including a wall and an interior that defines a light receiving cavity;
wherein the cells are arrayed in a manner such that each cell shares a wall with at least three other cells.

13. The reflection mitigation system of claim 12, wherein the cells include walls defining a plurality of hollow hexagonal cells.

14. The reflection mitigation system of claim 12, wherein the cells include walls defining a plurality of hollow circular cells.

15. The reflection mitigation system of claim 12, wherein the cells include walls defining a plurality of hollow circular cells having a diameter of between about 0.2 and 0.5 inches.

16. The reflection mitigation system of claim 12, wherein the cells include walls defining a plurality of hollow circular cells having a diameter of about 0.25 inches.
